(19) United States
(12) Patent Application Publication
(10) Pub. No.: US 2006/0192396 A1
(43) Pub. Date: Aug. 31, 2006

(54) Latch position sensor for door locks

(75) Inventors: George Frolov, Farmington, CT (US); Alfred S. Levesque, Newington, CT (US)

Correspondence Address: MICHAEL BEST & FRIEDRICH, LLP, 100 E WISCONSIN AVENUE, MILWAUKEE, WI, 53202, US

(73) Assignee: Harrow Products LLP, Montvale, NJ (US)

(21) Appl. No.: 11/068,947

(22) Filed: Feb. 28, 2005

(51) Int. Cl. E05C 1/12

(52) U.S. Cl. 292/169

(57) ABSTRACT

A latch assembly is for a lock of a door and includes a latch movably disposed within the door. A sensor is configured to sense when the latch is generally located at a particular position with respect to the door. Preferably, the latch is displaceable between an extended position, at which the latch is engageable with a strike, and a retracted position at which the door is moveable with respect to a frame, and the sensor preferably senses when the latch is located at at least one of these two positions. The sensor preferably includes a reed switch and a magnet, and preferably generates a signal when the latch is located at, or displaces from, the particular position. Further, the sensor is coupleable with either a processing device, such as a computer or controller, or an alarm device, such as a horn, a light or a speaker.

The present invention relates to locks, and more specifically to door locks including lock bars or latches.

Mechanical and electromechanical door locks generally include a lock bar engageable with a frame to secure the door therewithin. Such lock bars may either be a spring-biased latch or a positively locking deadbolt, which may be collectively referred to as “latches”, and are typically displaceable between retracted and extended positions. In the retracted position, the lock bar is disposed within a cavity or pocket of the door, such that the door is freely displaceable with respect to the frame. When located in the extended position, the lock bar is capable of securing the door to the frame.

### SUMMARY OF THE INVENTION

In one aspect, the present invention is a latch assembly for a lock of a door. The latch assembly comprises a latch movably disposed within the door and a sensor configured to sense when the latch is generally located at a particular position with respect to the door.

In another aspect, the present invention is a lock assembly for a door, the door being movably disposed within a frame. The lock assembly comprises a latch movably disposed within the door so as to be displaceable between an extended position, at which the door is secured to the frame, and a retracted position at which the door is displaceable with respect to the frame. A sensor is configured to sense when the latch is at least one of generally located at the extended position and generally located at the retracted position.

In a further aspect, the present invention is again a latch assembly for a door. The latch assembly comprises a latch moveably disposed within the door so as to be displaceable between an extended position and a retracted position. A sensor is configured to sense when the latch is either generally disposed at the retracted position or displacing generally toward the retracted position.

### BRIEF DESCRIPTION OF THE SEVERAL VIEWS OF THE DRAWINGS

The foregoing summary, as well as the detailed description of the preferred embodiments of the present invention, will be better understood when read in conjunction with the appended drawings. For the purpose of illustrating the invention, there is shown in the drawings, which are diagrammatic, embodiments that are presently preferred. It should be understood, however, that the present invention is not limited to the precise arrangements and instrumentalities shown. In the drawings:

FIG. 1 is a perspective view of a door having a lock incorporating the latch assembly in accordance with the present invention;

FIG. 2 is a side perspective view of the latch assembly and portions of the lock, showing the latch in an extended position;

FIG. 3 is another view of the latch assembly and lock components of FIG. 2, showing the latch in a retracted position;

FIG. 4 is rear perspective view of the latch and lock components;

FIG. 5 is a partly broken away, cross-sectional view through the latch assembly, the lock and the door of FIG. 1;

FIG. 6 is an exploded view of the latch assembly and lock components;

FIG. 7 is a partly broken-away, cross-sectional view through the latch assembly and lock components, showing the latch in the extended position;

FIG. 8 is another partly broken-away, cross-sectional view through the latch assembly and lock components, showing the latch in the retracted position; and

FIG. 9 is a more diagrammatic view of the latch assembly shown coupled with various electronic devices.

### DETAILED DESCRIPTION OF THE INVENTION

Certain terminology is used in the following description for convenience only and is not limiting. The words “right”, left”, “lower”, “upper”, “upward”, “down” and “downward” designate directions in the drawings to which reference is made. The words “inner”, “inwardly” and “outer”, “outwardly” refer to directions toward and away from, respectively, a designated centerline or a geometric center of an element being described, the particular meaning being readily apparent from the context of the description. Further, as used herein, the word “connected” is intended to include direct connections between two members without any other members interposed therebetween and indirect connections between members in which one or more other members are interposed therebetween. The terminology includes the words specifically mentioned above, derivatives thereof, and words of similar import.

Furthermore, the term “position” is used herein to indicate a position, location, configuration, orientation, etc., of one or more components of the lock assembly and each is depicted in the drawings with reference to a randomly selected point on the item being described. Such points in the drawing figures are randomly selected for convenience only and have no particular relevance to the scope of the present invention.

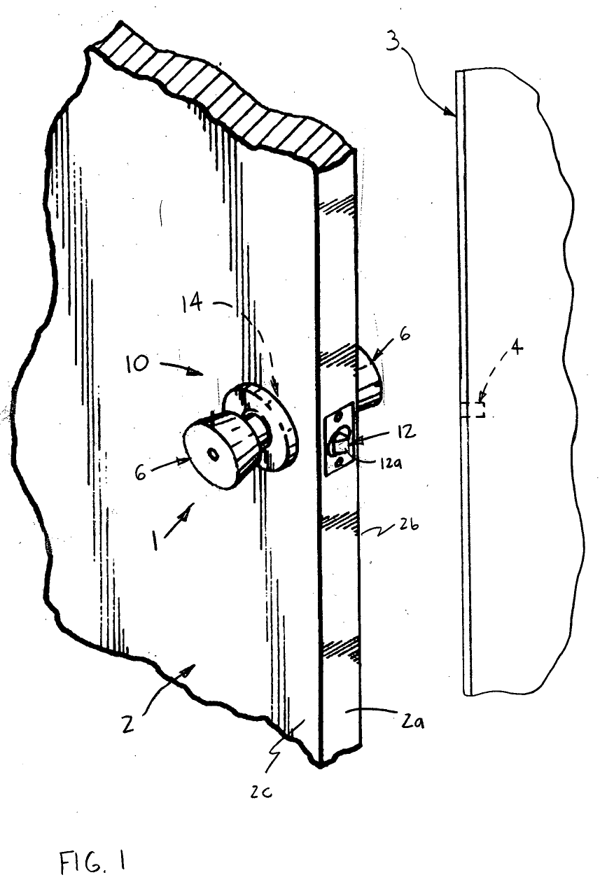

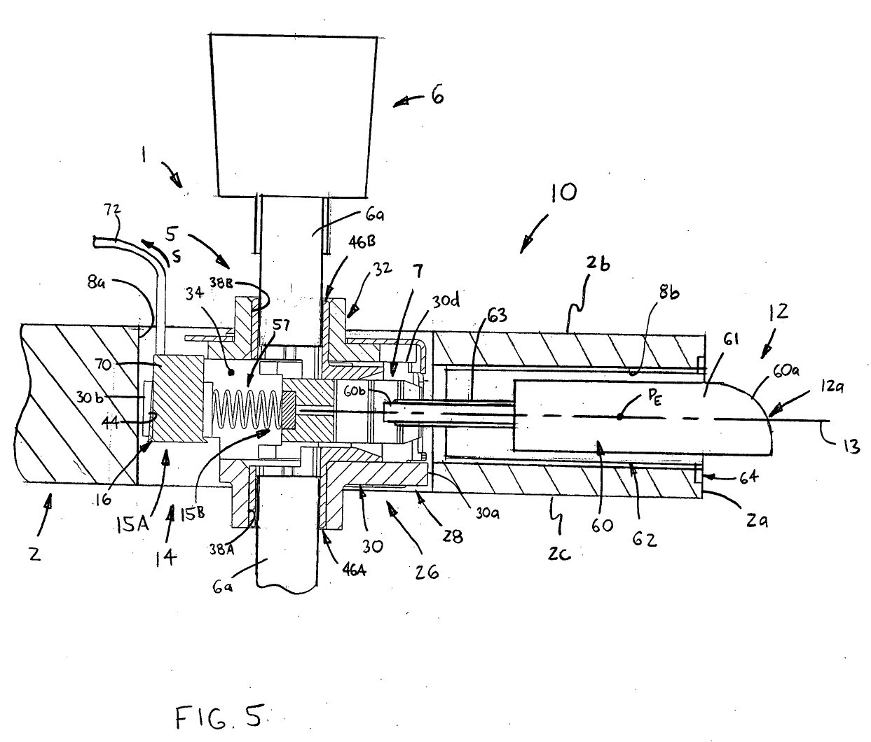

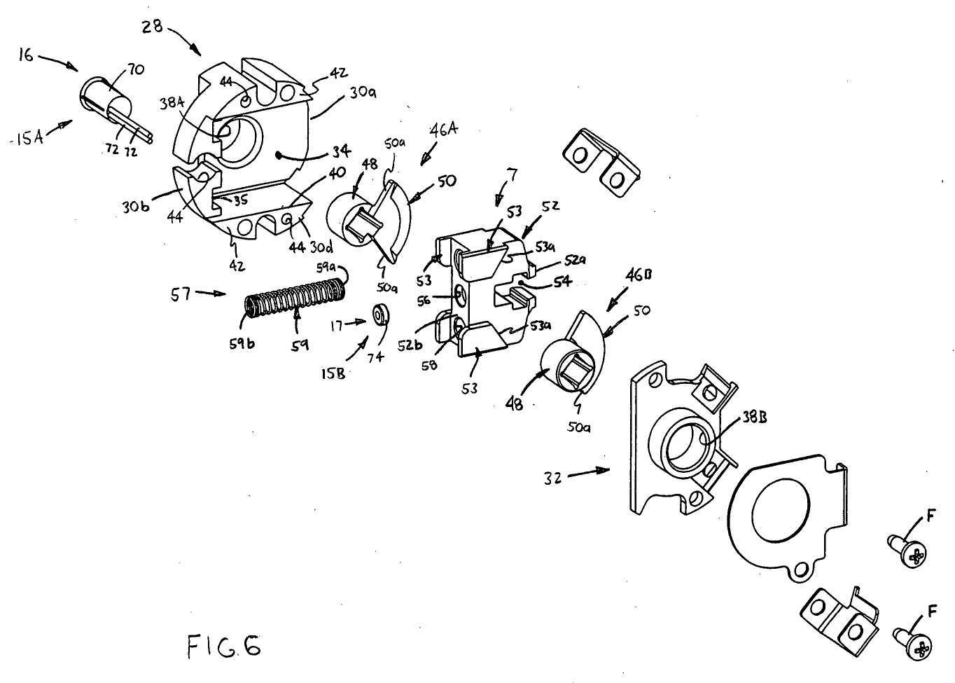

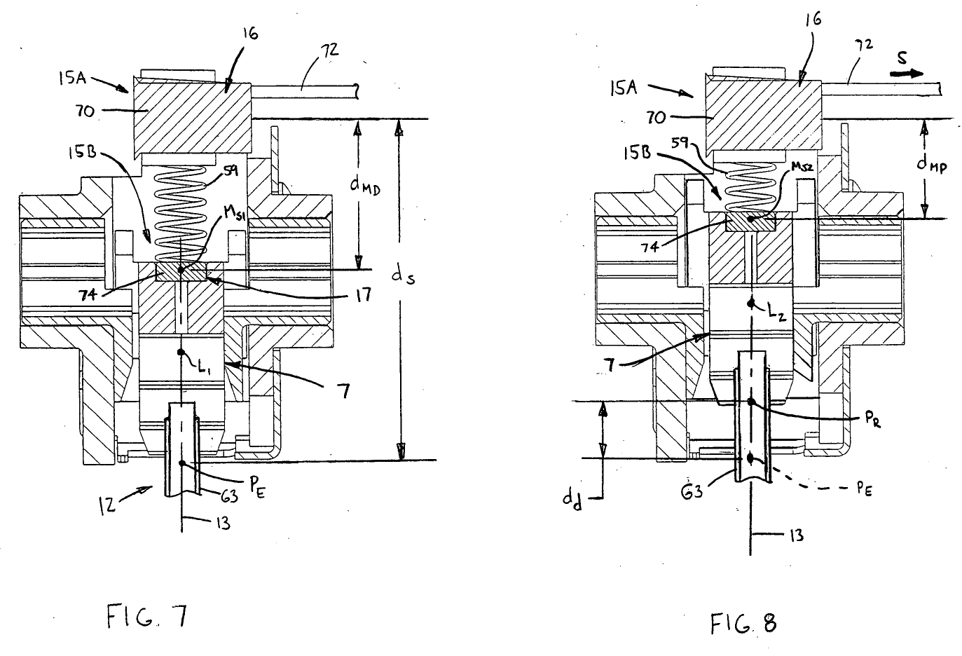

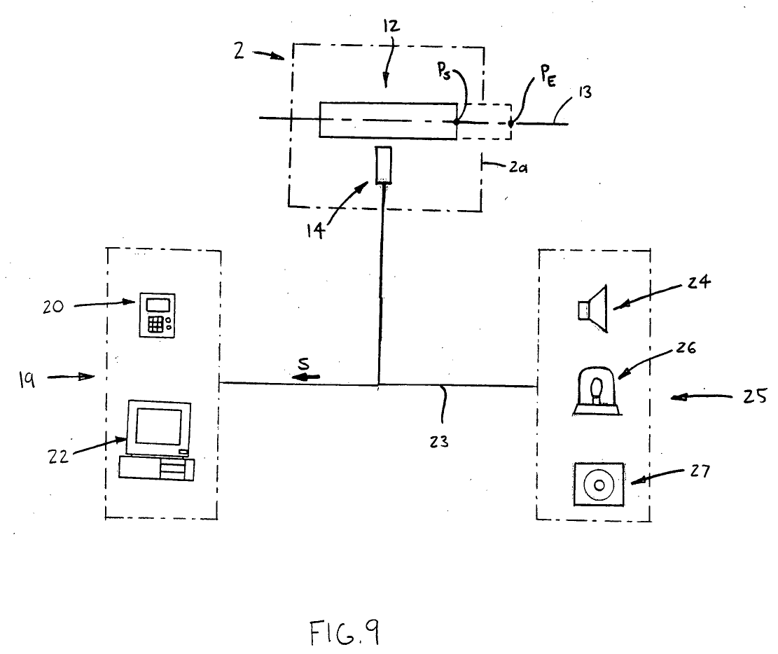

Referring now to the drawings in detail, wherein like numbers are used to indicate like elements throughout, there is shown in FIGS. 1-9 a latch assembly 10 for a lock 1 of a door 2, in accordance with the present invention. The door 2 is movably disposed within a frame 3 having a strike 4, the door 2 being displaceable between open and closed positions with respect to the frame 3 and having a side surface 2a disposed adjacent to the frame 3 when located at the closed position. The latch assembly 10 basically comprises a latch 12 movably disposed within the door 2 and a sensor 14 configured to sense when the latch 12 is generally located at a particular position P_{S} with respect to the door 2. As used herein and in the appended claims, the term “latch” encompasses spring-loaded latches retained in engagement with the door 2 by spring force, positively locking deadbolts retained in engagement with (or retracted from) the door 2 by a locking mechanism (not shown), and all other types of locking bar devices. In all of these cases, the latch 12 is displaceable, preferably linearly along a latch axis 13, between an extended position P_{E}, at which the latch 12 secures the door 2 within the frame 3, and a retracted position P_{R} with respect to the door 2, at which the door 2 is movable with respect to the frame 3. The sensor 14 is preferably configured to sense when the latch 12 is disposed at the retracted position P_{R} (i.e., P_{S}=P_{R}), as indicated in FIG. 8. Alternatively, the sensor 14 may be configured to sense when the latch 12 is disposed at the extended position P_{E} or at any position Pₙ located between the extended and retracted positions P_{E}, P_{R}, or even when the latch 12 is moving or displacing from any particular position P_{S}, as discussed below.

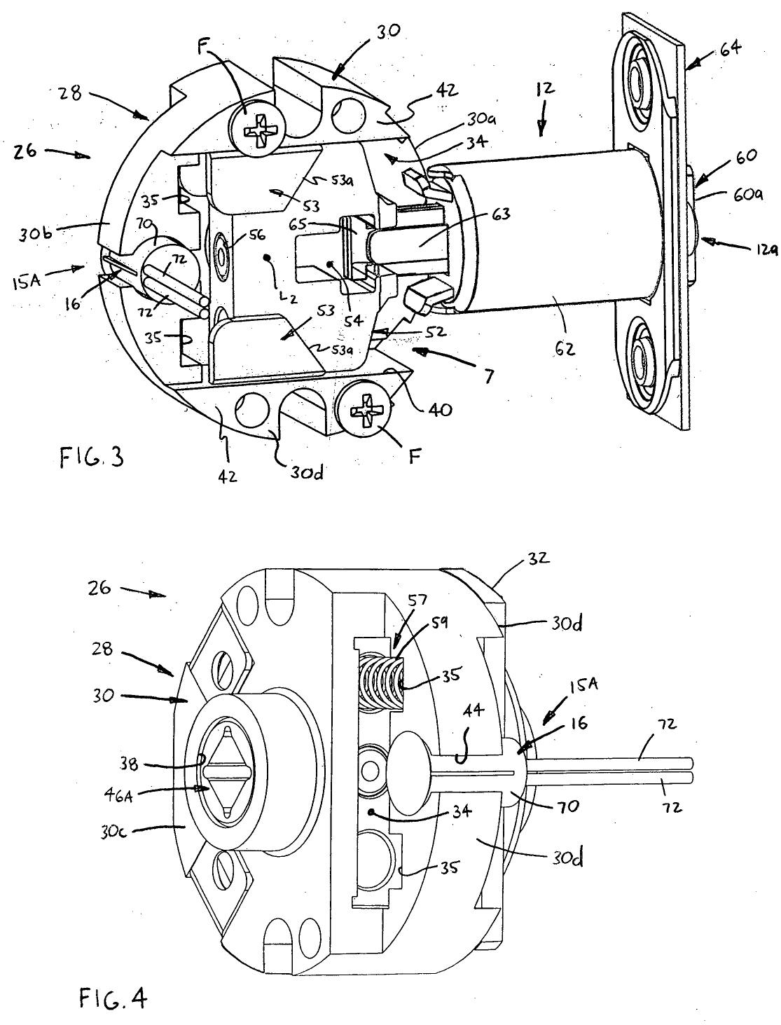

More specifically, the sensor 14 is configured to sense the latch 12 under at least one of the following conditions: when the latch 12 (or a component coupled therewith) is located generally proximal to the sensor 14 (see FIGS. 3 and 8), when the latch 12 (or connected component) is spaced or displaced by at least a predetermined distance ds from the sensor 14 (see FIG. 7), or when the latch 12 displaces/moves generally toward or/and away from the sensor 14. Preferably, the sensor 14 includes a first member 15A fixedly disposed within the door 2 and a second member 15B coupled with the latch 12. The sensor second member 15B is configured to activate the sensor first member 15A when the second member 15A is disposed at a position proximal to the first member 15A (e.g., M_{S2} in FIG. 8) or spaced by a least a predetermined distance d_{M} (FIG. 7) from the member 15A, and may be configured to activate the first member 15A in both cases. Most preferably, the first sensor member 15A is a reed switch 16 and the second sensor member 15B is a magnet 17, as described in further detail below.

However, the sensor first and second members 15A, 15B may be provided by any other appropriate components. For example, the first member 15A may be provided by a mechanical switch (not shown) and the second member 15B may be a device (e.g., a push rod, none shown) that closes or opens the switch. Further for example, the first sensor member 15A may be a light generator (e.g., a laser, none shown) configured to generate a light beam and the second member 15B may be an optical sensor (not shown) configured to sense the beam. Furthermore, the sensor 14 may be provided by a single component, such as a proximity sensor (e.g., an inductive sensor, etc.; none shown) configured to sense when the latch 12 or a component connected therewith is located proximal to, or moves from, the particular sensor 14. The scope of the present invention includes these and all other appropriate constructions of the sensor 14.

Referring to FIG. 8, the sensor 14 is preferably configured to generate a signal S either when the latch 12 is generally located at the particular position P_{S} or/and when the latch 12 displaces from the particular position P_{S}. In such cases, the sensor 14 is preferably coupleable with and configured to transmit the signal S to a processing device 19, such as a controller 20 or a computer 22, which may be incorporated into an access control system, an alarm or other security system, or any other appropriate application in which the sensor signal S may be useful (none shown). Alternatively, the sensor 14 may be coupleable with and configured to activate an electronic alarm device 25, such as a horn 24, a light 26, a speaker 27, etc., when the latch 12 is located at or moves from the particular position P_{S}. In other words, the sensor 14 may be a switch that merely functions to open or close a circuit 23 so as to thereby activate at least one electronic alarm device 25.

Furthermore, the latch assembly 10 is preferably used with lock 1 that includes a retractor 5 configured to displace the latch 12 between the extended and retracted positions P_{E}, P_{R} and at least one and preferably two handles 6 operatively connected with the retractor 5. As such, rotation of either handle 6 between a first, initial position (see, e.g., FIG. 1) and a second, displaced position (not shown) displaces the latch 12 between the extended and retracted positions P_{E}, P_{R}. The handles 6 may each include a knob (as shown), a lever, a thumbturn, or any other rotatable component that is manipulable by a user to operate the retractor 5. However, the lock 1 may alternatively include one or more push bars or any other components (no alternatives shown) for operating the retractor 5. Further, the retractor 5 preferably includes a slide 7 movably disposed within the door 1 and connected with the latch 12, the remainder of retractor 5 (described below) being configured to displace the slide 7 so as to move the latch 12 with respect to the door 1. However, the retractor 5 may include any other device for displacing the latch 12 between extended and retracted positions P_{E}, P_{R}, such as a tilting or pivoting bar, a cam mechanism or a linkage mechanism (e.g., four bar mechanism, etc.).

Additionally, the lock 1 preferably also includes a base 26 disposed at least partially within the door 2 and configured to rotatably support the one or two handles 6 and to house at least portions of the retractor 5. At least a portion of the sensor 14, preferably the sensor first member 15A (e.g., the reed switch 16) is coupled with the base 26 so as to mount to sensor 14 to the door 2. The base 26 preferably includes a generally cylindrical block 28 sized to fit within a through hole 8a extending between the door interior and exterior surfaces 2b, 2c, but may be formed in any other appropriate manner (e.g., as hollow box, a rectangular block, etc.). Alternatively, the lock 1 may be formed without any base, such that the sensor 14, the retractor 5 and the handle(s) 6 are separately disposed within or coupled with the door 2.

Having described the basic elements of the present invention above, these and other components of the latch assembly 12 are described in further detail below.

Referring first to FIGS. 1 and 5, the latch assembly 12 of the present invention is preferably used with a door 2 pivotally disposed within the frame 3, but may be alternatively slidably or otherwise movable with respect to the frame 3. The frame 3 preferably includes a strike 4 configured to receive an outer end 12a of latch 12 when the latch 12 is disposed at the extended position P_{E}. Further, the door 2 preferably further includes a latch cavity 8b extending between the through hole 8a and the door inner side edge 2a and sized to slidably receive the latch 12 and at least a portion of the retractor 5 coupled with the latch 12.

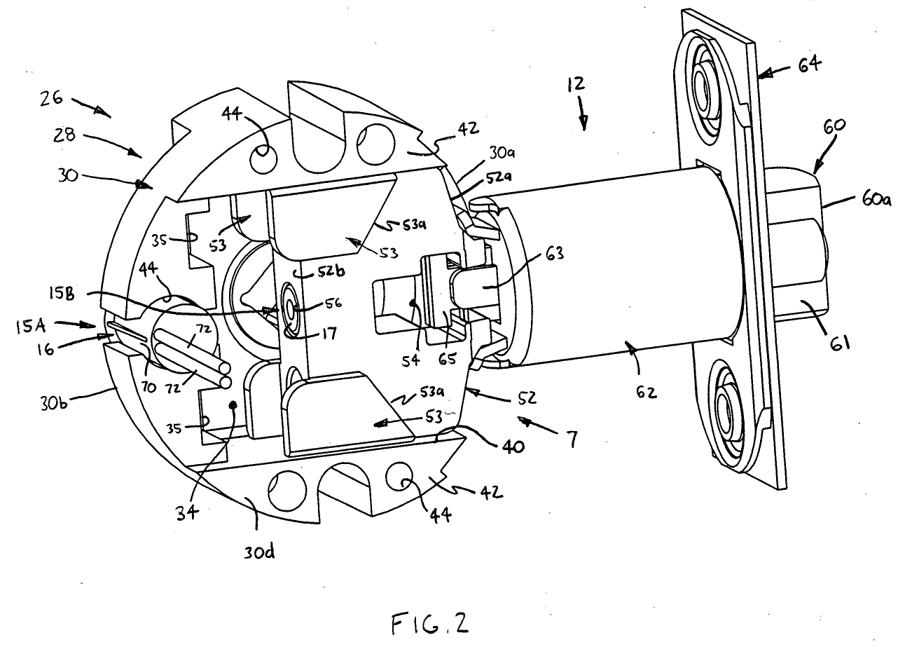

Referring to FIGS. 2-6, the base block 28 preferably includes a generally circular cylindrical main body 30 and a cover plate 32 removably attached to the main body 30. The main body 30 preferably has a generally rectangular recess or pocket 34, opposing front and rear ends 30a, 30b, and opposing side ends 30c, 30d. The pocket 34 is sized to receive the slide 7 and at least one and preferably two retainer pockets 35 extend rearwardly from the slide pocket 34, for reasons described below. The front end 30a has an opening 36 extending into the pocket 34 and sized to permit the slide 7 to displace therethrough. Further, one body side 30c has a generally circular bearing opening 38A extending into the pocket 34 and sized to receive a retractor hub 46A (described below). The other side 30d has a generally rectangular opening 40 extending into the pocket 34, mounting surface(s) 42 against which the cover plate 32 is disposeable, and a plurality of fastener holes 44 for receiving fasteners F used to attach the plate 32 to the main body 30. Furthermore, a generally circular cylindrical cavity 44 extends laterally between the two body sides 30c, 30d and is sized to receive the preferred first sensor member 15A, so as to mount the sensor member 15A to the base 26. Additionally, the cover plate 32 has a generally circular bearing opening 38B sized to receive another retractor hub 46B, the two bearing openings 38A, 38B being generally aligned with each other when the plate 32 is attached to the main body 30. When the plate 32 is disposed against the mounting surface(s) 42 and fastened to the main body 30 by the fasteners F, the plate 32 retains the slide 7 disposed within the base pocket 34.

Preferably, the retractor 5 further includes a pair of actuator spindles 46A, 46B each disposeable within a separate one of the base body bearing openings 38A, 38B. Each actuator spindle 46A, 46B has a circular cylindrical main body 48 and a generally circular-segment shaped drive plate 50 attached to the body 50. The hub main body 48 is engageable with a separate handle 6, preferably by means of a handle rod 6a disposed within a rectangular bore 48a of the main body 48. Further, the drive plate 50 has at least one and preferably two drive surfaces 50a engageable with a contact surface 53a of the slide 7 so as to linearly displace the slide 7 when the associated handle rotates the main body 48 within the bearing opening 38A, 38B, as described below.

Furthermore, the slide 7 is linearly displaceable between first position L₁ (FIGS. 2 and 7) and a second position L₂ (FIGS. 3 and 8) along the latch axis 13 and preferably includes a generally rectangular main body 52 and at least one and preferably four contact plates 53 attached to the body 52. The slide body 52 is sized to fit within the base body pocket 34 and has opposing front and rear ends 52a, 52b and opposing lateral sides 52c, 52d. An engagement opening 54 extends into the body 52 from the front end 52a and is configured to receive a rear portion 60b of the latch 12, as described below. A sensor mounting opening 56 extends into the body 52 from the rear end and is sized to receive the sensor second member 15B (i.e., the magnet 17) and at least one and preferably two retainer pockets 58 extending into the rear end and configured to receive an end 58a of a biasing member 58. Specifically, the retractor 5 preferably further includes at least one biasing member 57 configured to bias the slide 7 toward the slide first position L₁, and thereby bias the latch 12 toward the extended position P_{E}, as described in further detail below. The biasing member 57 is preferably a compression coil spring 59 having one end 59a disposed within one of the slide retainer pockets 58 and an another, opposing end 59b disposed within one of the retainer pockets 35 of the base body 30.

Additionally, each contact plate 53 has a contact surface 53a engageable by one drive surface 50a of a proximal actuator spindle 46A or 46B. As such, when one handle 6 rotates the connected actuator spindle 46A or 46B, the drive surface 50a of the attached spindle plate 50 pushes against the proximal contact surface 53a to push the slide 7 rearwardly or inwardly. Thereby, the latch 12 is displaced to the retracted position P_{R} against the biasing action of the preferred return spring 57. When the handle 6 is released, the return spring 57 displaces the slide 7 toward the slide first position L₁ to move the latch 12 to the extended position P_{E}. As the slide 7 displaces toward the second position L₂, the plate contact surface 53a pushes against actuator spindle drive surface 50a, causing the actuator spindle 46A or 46B to rotate within the associated base opening 38A, 38B and returns the connected handle 6 to the initial position (e.g., FIG. 1).

Although the above structure of the retractor 5 and the base 26 are presently preferred, the latch assembly 10 of the present invention may be used within any other type of lock 1. As such, the scope of the present invention is not in any manner limited by the structure of the lock 1, the specific structure described and depicted herein being used to illustrate the basic concepts of the latch assembly 10.

Referring now to FIGS. 2, 3 and 5, the latch 12 preferably includes a generally rectangular bar 60, a generally circular tubular housing 62 sized to contain a portion of the bar 60, and a mounting plate 64 attached to the housing 62. The latch bar 60 preferably has a relatively wider, main body portion 61 providing an angled front, outer end 60a engageable with the frame strike 4 and a relatively narrower, stem portion 63 providing a rear, inner end 60b engaged with the slide 7. Specifically, the stem portion 63 preferably has a T-shaped portion 65 disposed within engagement opening 54 of the slide main body 52, such that movement of the slide 7 slidably displaces the bar 60 within the housing 62. Further, the housing 62 is disposed within the door latch cavity 8b and the mounting plate 64 is attachable to the door side 2a so as to mount the latch 12 to the door 2. Although the above latch structure is presently preferred, the latch assembly 10 may be used with any appropriate type of latch 12 and the scope of the present invention is in no manner limited by the structure of the latch 12.

Referring to FIGS. 2-8, the preferred reed switch 16 is preferably a normally-open switch and has a generally cylindrical main body 70 and at least one and preferably two electrical lines or wires 72 attached to the main body 70. The main body 70 is preferably disposed within the base sensor cavity 44 and includes the reed switch elements (not shown). As reed switches are well known to those skilled in the art of sensors, a further description of the switch 16 is unnecessary and beyond the scope of the present disclosure. The wires 72 are electrically connectable with processing device 19, the alarm device 25 or any other electronic device, as best shown in FIG. 9. Further, the magnet 17 preferably includes a generally circular disk permanent magnet 74 disposed within the mounting opening 56 of the slide 7. Alternatively, the magnet 17 may be another type of permanent magnet or even an electromagnet.

In such a sensor arrangement, the sensor 14 is configured to directly sense when the slide 7 is located at particular position (e.g., L₂ in FIG. 8), so as to thereby indirectly sense a predetermined position P_{S} of the latch 12 (i.e., retracted position P_{R}). However, the sensor 14 may be constructed or/and arranged so as to directly sense when the latch 12 is located at a particular position P_{S}. For example, the magnet 17 (or the switch 16) may be mounted on the latch body 60 (arrangement not shown), or the sensor 14 may be a proximity sensor (not shown) located so as to directly sense the latch body 60. The scope of the present invention includes these and all other appropriate sensor constructions and arrangements capable of sensing when the latch 12 is located at at least one predetermined position P_{S}, and preferably also generating a signal S.

With the above structure, the presently preferred embodiment of the latch assembly 10 of the present invention basically operates in the following manner. When the latch 12 is retracted, either by rotating one of the handles 6 or by forcing the door 1 open, the slide 7 displaces a distance d_{d} (FIG. 8) from the first slide position L₁ (FIG. 7) toward the slide second position L₂. Such displacement of the slide 7 moves the magnet 17 generally proximal to the reed switch 16, preferably within a distance d_{MP}, causing the normally-open switch 16 to close. The closing of the reed switch 16 either provides an input signal S to a processing device 19 or activates an electronic alarm device 25. When the switch 16 is connected with the processing device 19, the processing device 19 stores a value or otherwise records an event record indicating the door 1 was opened, provides a notification (e.g., calls security), or/and activates an alarm device. However, the processing device 19 may utilize the signal S in any appropriate manner. Further, when the latch 12 is extended, preferably by means of the return spring 59, the slide 7 displaces toward the slide first position L₁ and moves the magnet 17 generally away from the reed switch 16, preferably by at least a distance d_{MD}, as indicated in FIG. 7. The normally-open switch 16 then adjusts back to the open configuration, which may cause the switch 16 to provide another input signal S to the processing device 19. However, when used with an alarm device 25, the opening of the switch 16 preferably does not deactivate such a device 25.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined in the appended claims.

We claim:

1. A latch assembly for a lock of a door, the latch assembly comprising:
a latch movably disposed within the door; and
a sensor configured to sense when the latch is generally located at a particular position with respect to the door.

2. The latch assembly as recited in claim 1 wherein:
the latch is displaceable between extended and retracted positions with respect to the door; and
the sensor is configured to sense when the latch is disposed at one of the retracted position and the extended position.

3. The latch assembly as recited in claim 1 wherein the sensor is further configured to generate a signal at least one of when the latch is generally located at the particular position and when the latch displaces from the particular position.

4. The latch assembly as recited in claim 3 wherein the sensor is coupleable with and configured to transmit the signal to one of a controller and a computer.

5. The latch assembly as recited in claim 1 wherein the sensor is coupleable with and configured to activate one of a horn and a light when the latch is located at the particular position.

6. The latch assembly as recited in claim 1 wherein the sensor is configured to sense at least one of when the latch is located generally proximal to the sensor and when the latch displaces at least a predetermined distance from the sensor.

7. The latch assembly as recited in claim 1 wherein:
the lock includes a retractor with a slide, the slide being movably disposed within the door and connected with the latch, the retractor being configured to displace the slide so as to move the latch with respect to the door; and
the sensor includes a first member fixedly disposed within the door and a second member connected with the slide and configured to activate the sensor first member when the second member is disposed at a position one of proximal to the first member and spaced from the first member.

8. The latch assembly as recited in claim 7 wherein the sensor first member includes a reed switch and the second sensor includes a magnet.

9. The latch assembly as recited in claim 1 wherein the lock includes a base disposed at least partially within the door and configured to rotatably support at least one handle, at least a portion of the sensor being coupled with the base so as to mount to sensor to the door.

10. The latch assembly as recited in claim 1 wherein the sensor includes:
a first member fixedly disposed within the door; and
a second member coupled with the latch so as to be displaceable between first and second positions, the first member being configured to generate a signal at least one of when the second member displaces toward the first position and when the second member displaces toward the second position.

11. The latch assembly as recited in claim 10 wherein the first member is a reed switch and the second member is a magnet.

12. The latch assembly as recited in claim 1 wherein the sensor includes a reed switch and a magnet.

13. The latch assembly as recited in claim 12 wherein the reed switch is fixedly mounted to the door and the magnet is coupled with the latch so as to be displaceable between a proximal position with respect to the switch and a distal position with respect to the switch, the reed switch being configured to generate a signal when the magnet is disposed at the proximal position and alternatively when the magnet is disposed at the distal position.

14. The latch assembly as recited in claim 12 wherein the reed switch is coupleable with one of a controller, a computer, a horn, a light, and a speaker.

15. The latch assembly as recited in claim 1 wherein the latch is releasably securable at the extended position.

16. A lock assembly for a door, the door being movably disposed within a frame, the lock assembly comprising:
a latch movably disposed within the door so as to be displaceable between an extended position at which the door is secured to the frame and a retracted position at which the door is displaceable with respect to the frame; and
a sensor configured to sense one of when the latch is generally located at the extended position and at the retracted position.

17. The lock assembly as recited in claim 16 wherein the sensor includes a reed switch fixedly mounted to the door and a magnet coupled with the latch so as to be displaceable between a proximal position with respect to the switch and a distal position with respect to the switch, the reed switch being configured to generate a signal at least one of when the magnet is disposed at the proximal position and when the magnet is disposed at the distal position.

18. The lock assembly as recited in claim 16 further comprising a retractor with a slide, the slide being movably disposed within the door and connected with the latch, the retractor being configured to displace the slide so as to move the latch between the extended and retracted positions, the sensor including a first member fixedly disposed within the door and a second member connected with the slide and configured to activate the first member when the latch is disposed one of generally at the extended position and generally at the retracted position.

19. The lock assembly as recited in claim 18 further comprising at least one handle operatively connected with the retractor and displaceable between a first position at which the latch is located at the extended position and a second position at which the latch is located at the retracted position.

20. The lock assembly as recited in claim 16 further comprising a base disposed at least partially within the door and configured to rotatably support at least one handle, at least a portion of the sensor being coupled with the base so as to mount to sensor to the door.

21. The lock assembly as recited in claim 16 wherein the sensor is coupleable with one of a controller, a computer, a horn, a light, and a speaker.

22. A latch assembly for a door, the latch assembly comprising:
a latch moveably disposed within the door so as to be displaceable between an extended position and a retracted position; and
a sensor configured to sense when the latch is one of generally disposed at least one at the retracted position and displacing generally toward the retracted position.

23. The latch assembly as recited in claim 22 wherein the sensor is further configured to sense when the latch is one of generally disposed at the extended position and displacing generally toward the extended position.
